(19) United States
(12) Patent Application Publication
(10) Pub. No.: US 2009/0284672 A1
(43) Pub. Date: Nov. 19, 2009

(54) Liquid Crystal Display and Method for Manufacturing the Same

(76) Inventors: Bong-Jin Baek, Hwaseong-si (KR); Hye-Sung Kim, Suyeong-gu (KR); Jae-Chang Kim, Dongrae-gu (KR); Tae-Hoon Yoon, Haewoondae-gu (KR); Won-Sang Park, Yongin-si (KR); Seong-Ryong Lee, Geumjeong-gu (KR)

Correspondence Address: F. CHAU & ASSOCIATES, LLC, 130 WOODBURY ROAD, WOODBURY, NY, 11797, US

(21) Appl. No.: 12/407,416

(22) Filed: Mar. 19, 2009

(30) Foreign Application Priority Data
May 16, 2008 (KR) 10-2008-0045507

(51) Int. Cl. G02F 1/133; H01J 9/395; H01J 9/26; G02F 1/13363

(52) U.S. Cl. 349/33; 445/53; 445/25; 349/119

(57) ABSTRACT

A liquid crystal display includes a first substrate, a second substrate facing an inside surface of the first substrate with a predetermined interval therebetween, a first electrode and a second electrode formed on at least one of the first substrate and the second substrate, partitions formed between the first substrate and the second substrate and dividing the space between the first substrate and the second substrate into a plurality of sub-spaces, and an OCB mode liquid crystal filled in the sub-spaces. The liquid crystal display is driven through a change of a bend arrangement by applying a second voltage that is less than the first voltage between the first electrode and the second electrode after being transitioned from an initial splay arrangement to a bend arrangement by applying a first voltage between the first electrode and the second electrode.

### CROSS-REFERENCE TO RELATED APPLICATION

This application claims priority to and the benefit of Korean Patent Application No. 10-2008-0045507 filed in the Korean Intellectual Property Office on May 16, 2008, the contents of which are incorporated herein by reference in their entirety.

### BACKGROUND OF THE INVENTION

(a) Field of the Invention

The present disclosure is directed to a liquid crystal display and a manufacturing method thereof, and particularly to an optically compensated bend (OCB) mode liquid crystal display and a manufacturing method thereof.

(b) Description of the Related Art

A liquid crystal display (LCD) is one of the most commonly used flat panel displays, and it includes two substrates with electrodes formed thereon and a liquid crystal layer interposed between the two substrates. In the LCD, a voltage is applied to the electrodes to realign liquid crystal molecules of the liquid crystal layer to thereby regulate the transmittance of light passing through the liquid crystal layer.

In recent years, the multimedia functions of portable devices such as mobile phones or portable media players (PMPs) have increased in importance, spurring interest in improving LCD display quality, response speed, and lowering power consumption for displaying motion pictures. The OCB mode has attracted interest due to a high response speed, a wide viewing angle, and excellent contrast ratio.

However, the OCB mode may have a back-flow in which an inverted transmittance is generated upon turning the electrical field on/off. Further, the liquid crystal is more stable in a bend arrangement than a splay arrangement, the transition from the bend arrangement to the splay arrangement is slow, requiring a high voltage for the transition, and the bend arrangement is challenging to maintain.

### SUMMARY OF THE INVENTION

Embodiments of the present invention provide an OCB mode liquid crystal display that is driven with a low voltage and that stably maintains a cell gap by forming a polymer partition.

According to an embodiment of the invention, a liquid crystal display including a first substrate, a second substrate having an inside surface facing an inside surface of the first substrate with a predetermined interval therebetween, a first electrode and a second electrode formed on at least one of the first substrate and the second substrate, a partition formed between the first substrate and the second substrate and dividing the space between the first substrate and the second substrate into a plurality of sub-spaces, and an OCB mode liquid crystal filled in the sub-spaces and driven through a change of a bend arrangement by applying a second voltage that is less than a first voltage between the first electrode and the second electrode after being transitioned from an initial splay arrangement to a bend arrangement by applying the first voltage between the first electrode and the second electrode is provided.

The OCB mode liquid crystal may be changed into the splay arrangement through a π-twisted arrangement under the application of an off voltage, the off voltage may be in the range of about 0- about 1.7V, the highest gray voltage of the second voltage may be in the range of about 6- about 8V, and the lowest gray voltage may be in the range of about 1.7- about 2.7V.

The partition may include a fluorinated polyacrylate, and a first alignment layer formed on the inside surface of the first substrate and rubbed in a first direction, and a second alignment layer formed on the inside surface of the second substrate and rubbed in the first direction, may be further included.

A first polarizer disposed on an outside surface of the first substrate and having a transmissive axis perpendicular to the first direction, a first biaxial compensation film disposed between the first substrate and the first polarizer, a second polarizer disposed on an outside of the second substrate and having a transmissive axis parallel to the first direction, and a second biaxial compensation film disposed between the second substrate and the second polarizer may be further included. A first ¼ wavelength phase retardation film disposed between the first substrate and the first polarizer and having a slow axis forming an angle of about 135 degrees with respect to the first direction, and a second ¼ wavelength phase retardation film disposed between the second substrate and the second polarizer and forming an angle of about 45 degrees with respect to the first direction may be further included.

The first electrode may be respectively formed in a pixel unit, and the partition may respectively enclose the respective first electrode, the first voltage may be in the range of about 7- about 8V, and the thickness of the partition may be equal to the interval between the first substrate and the second substrate, or in the range of about 5- about 6.5 um.

According to another embodiment of the invention, a method for manufacturing a liquid crystal display includes fabricating a first substrate and a second substrate, filling a mixture of a light polymerization monomer and a liquid crystal between the first substrate and the second substrate, and forming a partition by disposing a light mask on the outside of at least one of the first substrate and the second substrate and exposing the mixture of a light polymerization monomer and a liquid crystal to a light through the light mask to polymerize the light polymerization monomer.

The liquid crystal may be a π-twisted OCB mode liquid crystal that is transitioned from a splay arrangement to a bend arrangement according to application of a first electrical field, driven in a vertical bend arrangement and a curved bend arrangement according to the application of a second electrical field, and changed into the splay through a π-wisted arrangement under the application of an off voltage, and the mixture of a light polymerization monomer and a liquid crystal may be applied with a first electrical field when exposing the mixture of a light polymerization monomer and a liquid crystal to a light through the light mask to polymerize the light polymerization monomer in the forming of the partition.

The light polymerization monomer may be a fluorinated polyacrylate, and the monomer liquid crystal mixture may include the light polymerization monomer at about 5- about 15 wt % and a liquid crystal at about 95- about 85 wt %.

The liquid crystal mixture may be applied with a first electrical field when exposing to a light to polymerize the light polymerization monomer in the forming of the partition, fabricating the first substrate and the second substrate may include forming a plurality of spacers on at least one of the first substrate and the second substrate and forming a sealant on at least one of the first substrate and the second substrate, filling the mixture of the light polymerization monomer and the liquid crystal between the first substrate and the second substrate may include dripping the liquid crystal mixture on the substrate having the sealant of the first substrate and the second substrate and combining the first substrate and the second substrate, and the spacers may be column spacers disposed at positions where the partition is disposed.

Before filling the mixture of the light polymerization monomer and the liquid crystal between the first substrate and the second substrate, forming and rubbing a first alignment layer in a first direction on the first substrate, and forming and rubbing a second alignment layer in the first direction on the second substrate, may be further included. The process for polymerizing the light polymerization monomer may include phase separation of the liquid crystal and the monomer, and the light may be an ultraviolet (UV) ray.

According to an exemplary embodiment of the present invention, the liquid crystal molecules close to the partition are parallel to the surface of the polymer partition such that the pre-tilt may be easily transitioned into the bend arrangement thereby enabling a lower driving voltage.

Also, according to an exemplary embodiment of the present invention, the partition stably maintains the liquid crystal cell gap such that a liquid crystal display has a strong tolerance to external pressure.

### BRIEF DESCRIPTION OF THE DRAWINGS

FIG. 1 is an exploded perspective view of a liquid crystal display according to an exemplary embodiment of the present invention.

FIG. 2 is a schematic view showing a transition process of a liquid crystal of a π-twisted OCB mode used to the liquid crystal display according to an exemplary embodiment of the present invention.

FIG. 3 is a cross-sectional view inside the cell of a liquid crystal display according to an exemplary embodiment of the present invention.

FIG. 4 is a graph showing a characteristic brightness curve for the voltage of the liquid crystal display according to an exemplary embodiment of the present invention and an OCB mode liquid crystal display of the conventional art.

FIG. 5 shows a bruising characteristic of the liquid crystal display according to an exemplary embodiment of the present invention and an OCB mode liquid crystal display of the conventional art.

FIG. 6 is a view comparing a response speed curve of the liquid crystal display according to an exemplary embodiment of the present invention and an OCB mode liquid crystal display of the conventional art.

FIG. 7 is a graph comparing a viewing angle characteristic of the liquid crystal display according to an exemplary embodiment of the present invention and an OCB mode liquid crystal display of the conventional art.

FIG. 8 is a perspective view showing one step in a manufacturing process of a liquid crystal display according to an exemplary embodiment of the present invention.

### DETAILED DESCRIPTION OF EXEMPLARY EMBODIMENTS

Embodiments of the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, like reference numerals designate like elements throughout the specification. It will be understood that when an element such as a layer, film, region, or substrate is referred to as being “on” another element, it can be directly on the other element or intervening elements may also be present.

Now, a thin film transistor array panel according to an exemplary embodiment of the present invention will be described.

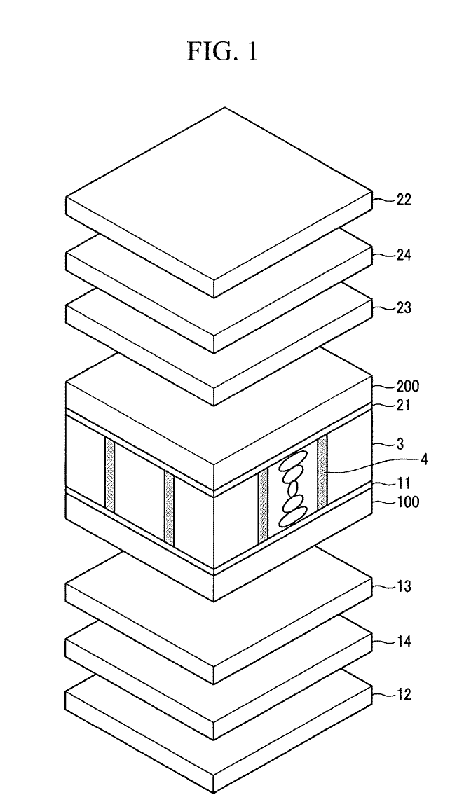

FIG. 1 is an exploded perspective view of a liquid crystal display according to an exemplary embodiment of the present invention.

A liquid crystal display according to an exemplary embodiment of the present invention includes a liquid crystal panel including a thin film transistor array panel 100 having an alignment layer 11, a common electrode panel 200 having an alignment layer 21, partitions 4 and a liquid crystal layer 3, biaxial compensation films 13 and 23, ¼ wavelength phase retardation films 14 and 24, and polarizers 12 and 22, which are disposed on both sides of the liquid crystal panel.

Although not shown, the thin film transistor array panel 100 also includes wiring such as gate lines, a data lines, thin film transistors as switching elements, and pixel electrodes applied with image voltages through the thin film transistors. The first alignment layer 11 is formed on the inside surface of the thin film transistor array panel 100. The first alignment layer 11 is rubbed in one direction (hereinafter referred to as “the first direction”).

In addition, although not shown, the common electrode panel 200 includes a common electrode forming an electrical field in the liquid crystal layer 3 along with the pixel electrodes, a color filter, and a light blocking member. If necessary, the common electrode, the color filter, and the light blocking member may be formed in the thin film transistor array panel 100. The second alignment layer 21 is formed on the inside surface of the common electrode panel 200, and the second alignment layer 21 is also rubbed in the first direction.

The partitions 4 are made of a polymer such as poly-fluorinated acrylates and are formed between the thin film transistor array panel 100 and the common electrode panel 200, and the space between the thin film transistor array panel 100 and the common electrode panel 200 is divided into a plurality of sub-spaces. Here, the sub-spaces may be pixel spaces corresponding to the pixel electrodes. That is, the partitions may be formed of a shape enclosing the pixel electrodes, and the thickness of the partitions may be equal to the cell gap between the thin film transistor array panel 100 and the common electrode panel 200, or in the range of about 5-6.5 um.

A liquid crystal of a π-twisted OCB mode is filled in each sub-space divided by the partitions 4, thereby forming the liquid crystal layer 3. The π-twisted OCB mode liquid crystal is an OCB mode liquid crystal that passes through the twisted arrangement state of 180 degrees as a middle step of a transition from a bend arrangement to a splay arrangement.

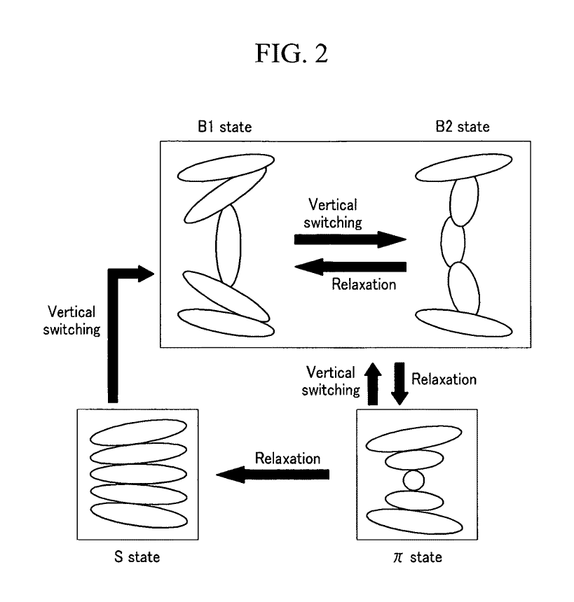

The π-twisted OCB mode liquid crystal will be described in more detail with reference to FIG. 2. FIG. 2 is a schematic view showing a transition process of a liquid crystal of a π-twisted OCB mode used in the liquid crystal display according to an exemplary embodiment of the present invention.

The π-twisted OCB mode liquid crystal is aligned to form an initial splay arrangement S, depicted in the “S state” sub-figure of FIG. 2. In an exemplary embodiment of the present invention, the first alignment layer 11 and the second alignment layer 21 are rubbed in the same direction such that the liquid crystal forms the splay arrangement. If a transition voltage is applied, the liquid crystal transitions from the splay arrangement S to the first bend arrangement state, B1 (a curved bend arrangement), as indicated by the arrow labeled “Vertical switching”. Here, the transition voltage may be in the range of 7-8V. If a gray voltage is applied in this state, the arrangement of the liquid crystal is changed between the first bend arrangement state B1 and a second bend arrangement state B2, a vertical bend arrangement indicated by the “vertical switching” arrow, thereby displaying images. In an exemplary embodiment of the present invention, the lowest limit of the gray voltage is in the range of about 1.7-2.7V, and the highest limit is in the range of about 6-8V. In particular, voltages between 2.2V and 7V may be used as the gray voltages. In the first bend arrangement state B1, if a voltage of less than a predetermined value is applied, the first bend arrangement state B1 does not return into the splay arrangement S, but transitions into the π-twisted arrangement state, indicated by the “Relaxation” arrow in the figure. If the voltage is continuously decreased, the liquid crystal return from the π-twisted arrangement state to the splay arrangement state S. The voltage of the liquid crystal changes from the first bend arrangement state B1 to the splay arrangement state S through the π-twisted arrangement state. The π state corresponds to an off voltage, and may be in the range of about 0-1.7V. If the voltage applied to the liquid crystal is lowered to less than the gray voltage range, for example, less than about 1.7V, the liquid crystal of the first bend arrangement state B1 relaxes, transitions to the π-twisted arrangement state, and returns to the splay arrangement S state. The transition voltage and the gray voltage are applied to the liquid crystal by forming a potential difference between the pixel electrode and the common electrode, as indicated by the arrows labeled “Relaxation”.

The first polarizer 12 and the second polarizer 22 are respectively disposed on the outside surface of the thin film transistor array panel 100 and the common electrode panel 200, the first biaxial compensation film 13 and the first ¼ wavelength phase retardation film 14 are disposed between the first polarizer 12 and the thin film transistor array panel 100, and the second biaxial compensation film 23 and the second ¼ wavelength phase retardation film 24 are disposed between the second polarizer 22 and the common electrode panel 200.

The transmissive axis of the first polarizer 12 is parallel to the first direction which is the rubbing direction of the alignment layers 11 and 21, and the transmissive axis of the second polarizer 22 is perpendicular to the first direction. Alternatively, the transmissive axis of the first polarizer 12 may be perpendicular to the first direction, and the transmissive axis of the second polarizer 22 may be parallel to the first direction.

The slow axis of the first ¼ wavelength phase retardation film 14 forms an angle of 45 degrees with the first direction, and the slow axis of the second ¼ wavelength phase retardation film 24 forms an angle of 135 degrees with the first direction.

The π-twisted OCB mode includes liquid crystal molecules parallel to the surfaces of the display panels 100 and 200 in the contact portions of the alignment layers 11 and 21 even in a black state. Accordingly, phase retardationof the polarized light is generated by the liquid crystal layer 3, thereby generating light leakage. Accordingly, the first and second biaxial compensation films 13 and 23 and the first and second ¼ wavelength phase retardation films 14 and 24 are disposed to offset the phase retardation generated in the liquid crystal layer 3 to reduce the luminance in the black state.

A liquid crystal display according to an exemplary embodiment of the present invention is driven by a low driving voltage having a low power consumption and has an excellent bruising characteristic. The exellent bruising characteristic refers to the liquid crystal cell gap being maintained when pressure is applied to the liquid crystal display, or when the liquid crystal display is shaken, such that the display quality is maintained.

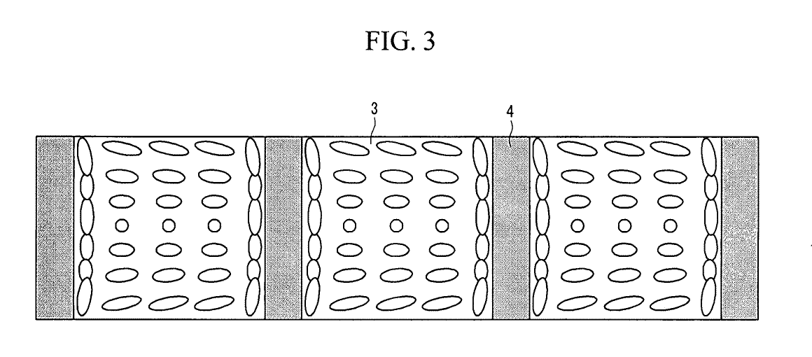

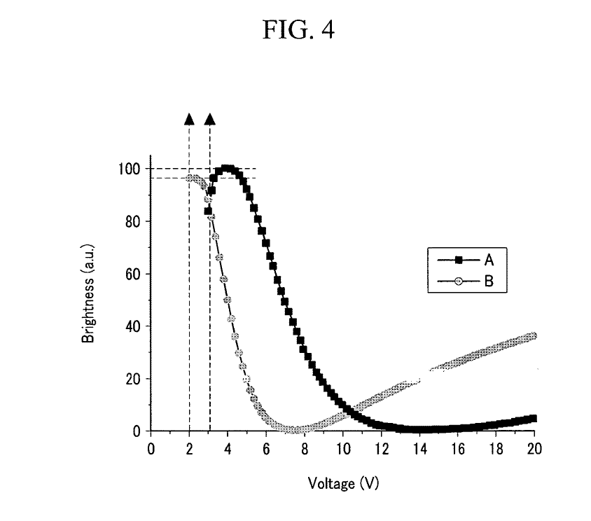

A liquid crystal display according to an exemplary embodiment of the present invention having a low driving voltage will be described with reference to FIG. 3 and FIG. 4. FIG. 3 is a cross-sectional view inside a cell of a liquid crystal display according to an exemplary embodiment of the present invention, and FIG. 4 is a graph showing brightness characteristic curves B and A as a function of voltage of a liquid crystal display according to an exemplary embodiment of the present invention and an OCB mode liquid crystal display of the conventional art.

Referring to FIG. 3, the liquid crystal molecules contacted with the polymer partitions 4 are parallel to the surface of the wall made by the partitions 4 and form an arrangement similar to the bend arrangement. Accordingly, the splay arrangement mat easily transition into the bend arrangement, and the splay arrangement may also easily transition into the bend arrangement by application of a low voltage. Referring to FIG. 4, a liquid crystal display B according to an exemplary embodiment of the present invention has a lower white voltage of about 2.2V and a black voltage of about 7V compared with the conventional OCB mode liquid crystal display A that is driven between a white voltage of about 3.2V and a black voltage of about 14V. The black voltage of display B (about 7V) corresponds to the secondary bend arrangement state B2 of FIG. 2, and the white voltage (about 2.2V) corresponds to the first bend arrangement state B1 that previously transitioned into the π-twisted arrangement state π.

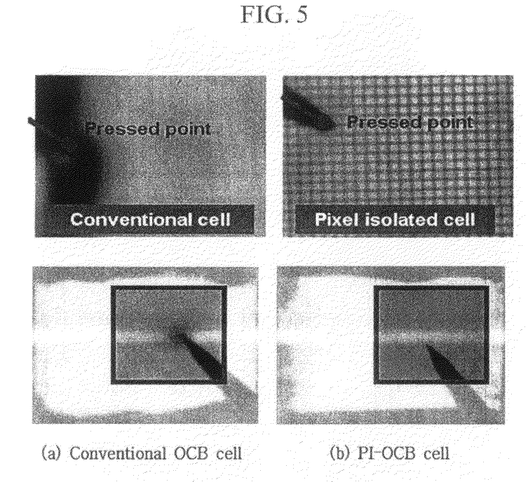

Next, the bruising characteristic of a liquid crystal display according to an exemplary embodiment of the present invention will be described with reference to FIG. 5. FIG. 5 illustrates a bruising characteristic of a liquid crystal display according to an exemplary embodiment of the present invention and an OCB mode liquid crystal display of the conventional art.

A liquid crystal display according to an exemplary embodiment of the present invention includes partitions that are closely formed between thin film transistor array panel 100 and the common electrode panel 200 such that the cell gap of the liquid crystal layer 3 does not significantly change from the application of external pressure. As shown in FIG. 5, if a pressure is applied to the conventional OCB mode liquid crystal display, the display state near the pressed point is violently distorted, as shown in the left side images of FIG. 5, but a pressure application to a liquid crystal display accordingly to an exemplary embodiment of the present invention causes little change to the display state, as shown in the right side images of FIG. 5.

Also, a liquid crystal display according to an exemplary embodiment of the present invention has essentially the same response speed and viewing angle as the conventional OCB mode liquid crystal display.

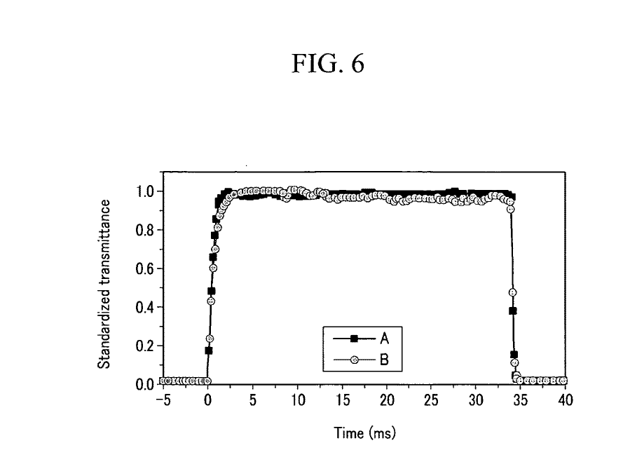

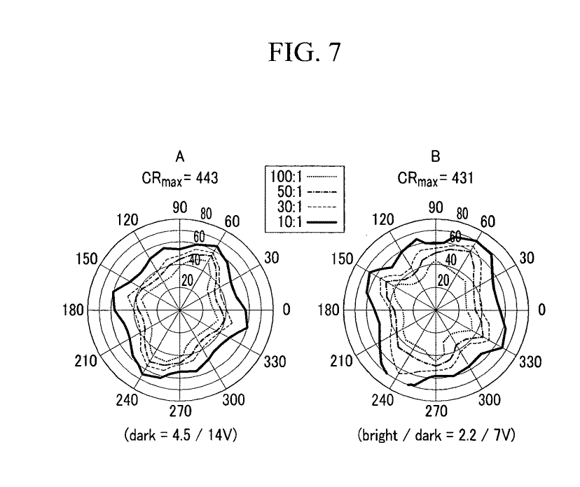

FIG. 6 is a view comparing a response speed curve of a liquid crystal display according to an exemplary embodiment of the present invention (B) and an OCB mode liquid crystal display of the conventional art (A), and FIG. 7 is a graph comparing a viewing angle characteristic of a liquid crystal display according to an exemplary embodiment of the present invention (the “B” image on the right side) and an OCB mode liquid crystal display of the conventional art (the “A” image on the left side).

Firstly, referring to FIG. 6, a response speed curve of a liquid crystal display according to an exemplary embodiment of the present invention is essentially identical to a response speed curve of the conventional OCB mode liquid crystal display. That is, a rising time and falling time due to the transmittance of a liquid crystal display according to an exemplary embodiment of the present invention is essentially the same as that of the conventional OCB mode liquid crystal display.

Referring to FIG. 7, the area inside the closed curvefor each contrast ratio of a liquid crystal display according to an exemplary embodiment of the present invention is essentially the same as the area inside the closed curvefor each contrast ratio of the conventional OCB mode liquid crystal display. Thus, there is no significant difference between the viewing angle characteristic of the two.

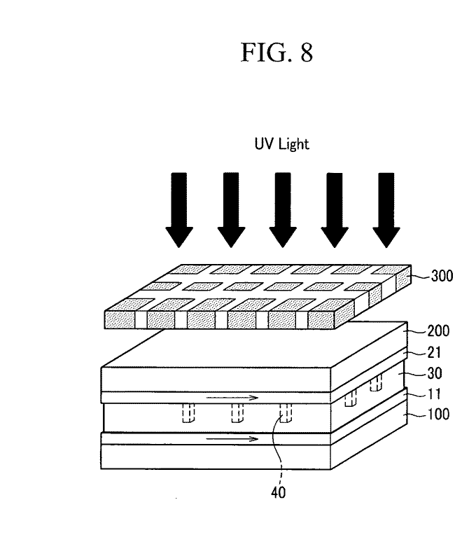

Next, a manufacturing method of a liquid crystal display according to an exemplary embodiment of the present invention will be described with reference to FIG. 8.

First, a thin film transistor array panel 100 is provided by forming thin film patterns such as gate wires, a gate insulating layer, a semiconductor layer, an ohmic contact layer, data wires, a passivation layer, and pixel electrodes on an insulating substrate. Here, a color filter and a light blocking member may be formed on the thin film transistor array panel 100. Next, a material such as a polyimide is coated on the thin film transistor array panel 100 and rubbed to form the first alignment layer 11. Also, a common electrode panel 200 is provided by forming a thin film pattern such as a common electrode on an insulating substrate, and a material such as a polyimide is coated on the common electrode panel 200 and rubbed to form the second alignment layer 21. The alignment layers 11 and 21 may be formed of a material such as SE3140 from Chisso Corporation.

Next, a photosensitive organic material is coated on the common electrode panel 200 having the second alignment layer 21, exposed, and developed to form column spacers 40. The column spacers 40 may be disposed at positions where partitions will be formed. Also, the column spacers 40 may be formed on the first alignment layer 11 of the thin film transistor array panel 100. The height of the column spacers 40 is almost the same as the cell gap. Ball spacers may be dispersed as an alternative to the column spacers 40.

Next, a sealant 30 with a closed line shape is coated on the common electrode panel 200, and a mixed monomer liquid crystal mixture of a π-twisted OCB mode liquid crystal and a light polymerization monomer such as a fluorinated acrylate is dripped into the region defined by the sealant 30. The monomer liquid crystal mixture may include the light polymerization monomer at 5-15 wt % and the liquid crystal at 95-85 wt %. When the amount of the light polymerization monomer is less than 5 wt %, it may be challenging to form partitions through the light polymerization, and when the amount of the light polymerization monomer is more than 15 wt %, some amount of the monomer may exist in the liquid crystal layer after forming the partitions through the light polymerization, possibly disturbing the driving of the liquid crystal. The liquid crystal may use MLC6265-100 from Merck & Co., Inc. Here, the formation of the sealant 30 and the dripping of the monomer liquid crystal mixture may be performed on the thin film transistor array panel 100.

Next, the common electrode panel 200 and the thin film transistor array panel 100 are aligned and combined, and ultraviolet rays are irradiated to harden the sealant 30. Also, an exposure mask 300 having a transmitting portion with a lattice shape is disposed on the common electrode panel 200, and the ultraviolet rays are irradiated through the exposure mask 300 to form partitions by light-polymerizing the monomer included in the monomer liquid crystal mixture. The ultraviolet irradiation for the light polymerization of the monomer is performed in a state in which the transition voltage is applied between the pixel electrode and the common electrode to form the bend arrangement of the liquid crystal to simulate the force needed to similarly arrange the liquid crystal near the partition with the bend arrangement. Here, the bend arrangement may be the first bend arrangement state B1 shown in FIG. 2, but it may also be second bend arrangement state B2. On the other hand, the ultraviolet irradiation to harden the sealant 30 and the ultraviolet irradiation to light-polymerize the monomer may be simultaneously performed. Phase separation of the liquid crystal and the monomer may be included in the the ultraviolet irradiation to polymerize the monomer.

The monomer liquid crystal mixture has been described as being dripped to fill the space between the two display panels 100 and 200, however the monomer liquid crystal mixture may be injected in the space between the two display panels 100 and 200 after the combination of the two display panels 100 and 200 by using a pressure difference.

After completing the partitions, the various compensation films and polarizers are disposed, and a liquid crystal display is completed through a module process.

While embodiments of this invention has been described in connection with what is presently considered to be practical exemplary embodiments, it is to be understood that other embodiments of the invention are not limited to the disclosed embodiments, but, on the contrary, are intended to cover various modifications and equivalent arrangements included within the spirit and scope of the appended claims.

What is claimed is:

1. A liquid crystal display comprising:
a first substrate;
a second substrate having an inside surface facing an inside surface of the first substrate with a predetermined interval therebetween;
a first electrode and a second electrode formed on at least one of the first substrate and the second substrate;
a partition formed between the first substrate and the second substrate, and dividing the space between the first substrate and the second substrate into a plurality of sub-spaces; and
an OCB mode liquid crystal filled in the sub-spaces, and driven through a change of a bend arrangement by applying a second voltage that is less than a first voltage between the first electrode and the second electrode after being transitioned from an initial splay arrangement to a bend arrangement by applying the first voltage between the first electrode and the second electrode.

2. The liquid crystal display of claim 1, wherein
the OCB mode liquid crystal is changed into the splay arrangement through a π-twisted arrangement under the application of an off voltage.

3. The liquid crystal display of claim 2, wherein
the off voltage is in the range of about 0- about 1.7V.

4. The liquid crystal display of claim 1, wherein
a highest gray voltage of the second voltage is in the range of about 6- to about 8V, and a lowest gray voltage of the second voltage is in the range of about 1.7- about 2.7V.

5. The liquid crystal display of claim 1, wherein
the partition includes a fluorinated polyacrylate.

6. The liquid crystal display of claim 1, further comprising:
a first alignment layer formed on the inside surface of the first substrate and rubbed in a first direction; and
a second alignment layer formed on the inside surface of the second substrate and rubbed in the first direction.

7. The liquid crystal display of claim 6, further comprising:
a first polarizer disposed on an outside surface of the first substrate, and having a transmissive axis vertical to the first direction;
a first biaxial compensation film disposed between the first substrate and the first polarizer;
a second polarizer disposed on an outside of the second substrate and having the transmissive axis parallel to the first direction; and
a second biaxial compensation film disposed between the second substrate and the second polarizer.

8. The liquid crystal display of claim 7, further comprising:
a first ¼ wavelength phase retardation film disposed between the first substrate and the first polarizer, and having a slow axis forming an angle of about 135 degrees with respect to the first direction; and
a second ¼ wavelength phase retardation film disposed between the second substrate and the second polarizer, and forming an angle of about 45 degrees with respect to the first direction.

9. The liquid crystal display of claim 1, wherein
the first electrode is respectively formed in a pixel unit, and the partition encloses the respective first electrode.

10. The liquid crystal display of claim 1, wherein
the first voltage is in the range of about 7- to about 8V.

11. The liquid crystal display of claim 1, wherein
the thickness of the partition is equal to the interval between the first substrate and the second substrate.

12. The liquid crystal display of claim 1, wherein the thickness of the partition is in the range of about 5- about 6.5 um.

13. A method for manufacturing a liquid crystal display comprising:
fabricating a first substrate and a second substrate;
filling a mixture of a light polymerization monomer and a liquid crystal between the first substrate and the second substrate; and
forming a partition by disposing a light mask on the outside of at least one of the first substrate and the second substrate and exposing the mixture of a light polymerization monomer and a liquid crystal to a light through the light mask to polymerize the light polymerization monomer.

14. The method of claim 13, wherein
the liquid crystal is a π-twisted OCB mode liquid crystal that transitions from a splay arrangement to a bend arrangement according to application of a first electrical field, is driven in a vertical bend arrangement and a curved bend arrangement according to an application of a second electrical field, and changes into the splay arrangement through a π-twisted arrangement under an application of an off voltage.

15. The method of claim 13, wherein
the mixture of a light polymerization monomer and a liquid crystal is applied with a first electrical field when exposing the mixture of a light polymerization monomer and a liquid crystal to light through the light mask to polymerize the light polymerization monomer in the forming of the partitions.

16. The method of claim 15, wherein
the light polymerization monomer is a fluorinated polyacrylate.

17. The method of claim 16, wherein
the monomer liquid crystal mixture includes the light polymerization monomer at about 5- about 15 wt % and a liquid crystal at about 95- about 85 wt %.

18. The method of claim 13, wherein:
fabricating the first substrate and the second substrate includes forming a plurality of spacers on at least one of the first substrate and the second substrate, and forming a sealant on at least one of the first substrate and the second substrate; and
filling the mixture of the light polymerization monomer and the liquid crystal between the first substrate and the second substrate includes dripping the liquid crystal mixture on the substrate having the sealant of the first substrate and the second substrate, and combining the first substrate and the second substrate.

19. The method of claim 18, wherein
the spacers are column spacers disposed at positions where the partition is disposed.

20. The method of claim 13, further comprising,
before filling the mixture of the light polymerization monomer and the liquid crystal between the first substrate and the second substrate:
forming and rubbing a first alignment layer in a first direction on the first substrate; and
forming and rubbing a second alignment layer in the first direction on the second substrate.

21. The method of claim 13, wherein
the process for polymerizing the light polymerization monomer includes phase separation of the liquid crystal and the monomer.

22. The method of claim 13, wherein
the light is an ultraviolet (UV) ray.

23. A liquid crystal display comprising:
a first substrate;
a second substrate spaced apart from said first substrate by a predetermined interval;
a fluorinated polyacrylate partition formed between the first substrate and the second substrate, and dividing the space between the first substrate and the second substrate into a plurality of sub-spaces; and
an OCB mode liquid crystal filled in the sub-spaces, and driven through a change of a bend arrangement by applying a second voltage that is less than a first voltage after being transitioned from an initial splay arrangement to a bend arrangement by applying the first voltage, wherein the OCB mode liquid crystal is changed into the splay arrangement through a π-twisted arrangement under the application of an off voltage.

24. The liquid crystal display of claim 23, further comprising:
a first electrode and a second electrode formed on at least one of the first substrate and the second substrate, wherein said first voltage is applied between the first electrode and the second electrode and the second voltage is applied between the first electrode and the second electrode.
